(19) United States
(12) Patent Application Publication
(10) Pub. No.: US 2024/0375624 A1
(43) Pub. Date: Nov. 14, 2024

(54) APPARATUS AND METHOD FOR ESTIMATING INCLINATION OF VEHICLE

(71) Applicants: HYUNDAI MOTOR COMPANY, Seoul (KR); KIA CORPORATION, Seoul (KR)

(72) Inventor: Jin Seok SONG, Bucheon-si (KR)

(73) Assignees: HYUNDAI MOTOR COMPANY, Seoul (KR); KIA CORPORATION, Seoul (KR)

(21) Appl. No.: 18/375,276

(22) Filed: Sep. 29, 2023

(30) Foreign Application Priority Data
May 11, 2023 (KR) 10-2023-0061224

(51) Int. Cl. B60T 8/1755

(52) U.S. Cl. CPC B60T 8/17551; B60T 2250/03; B60T 2250/04

(57) ABSTRACT

An apparatus for estimating inclination of a vehicle includes a vehicle information receiver configured to collect travel information of the vehicle including a wheel speed, a driving torque, and a longitudinal acceleration sensor value, a vehicle stop determinator configured to determine, based on the travel information received from the vehicle information receiver, whether the vehicle satisfies a vehicle stop condition, a disturbance corrector configured to correct disturbance of the longitudinal acceleration sensor value depending on whether the vehicle stop condition is satisfied, and An inclination estimator configured to estimate the inclination of the vehicle using a longitudinal acceleration input value corrected by the disturbance corrector.

### CROSS-REFERENCE TO RELATED APPLICATION(S)

The present application claims priority to Korean Patent Application No. 10-2023-0061224 filed on May 11, 2023, the entire contents of which is incorporated herein for all purposes by this reference.

### BACKGROUND OF THE INVENTION

### Field of the Invention

The present disclosure relates to an apparatus and method for estimating inclination of a vehicle.

### Description of Related art

Inclination of a vehicle or inclination of a road may act as important factors in vehicle control. For example, the vehicle may be held with appropriate brake pressure when stopped on an inclination, and appropriate engine torque may be applied when the vehicle starts from the inclination. In addition, in the case of a cruise control system, which is a function of driving a vehicle at a constant speed, the speed of the vehicle may change whenever inclination of a road surface is changed, unless the inclination of the road surface is determined in advance.

In order to measure inclination of a road, a method for directly extracting inclination of a road surface by attaching, to a vehicle, a sensor for measuring inclination, such as a level meter, a gravity sensor, or the like, may be used. However, the high price of the level meter not only increases the price of the vehicle, but also has a significant disadvantage in controlling other actuators due to a slow response of the sensor. In addition, when the gravity sensor is used, noise elements, such as road impact and the like, in addition to the inclination of the road surface may still exist, resulting in a severe error.

The information disclosed in this Background of the Invention section is only for enhancement of understanding of the general background of the invention and may not be taken as an acknowledgement or any form of suggestion that this information forms the related art already known to a person skilled in the art.

### BRIEF SUMMARY

Various aspects of the present disclosure are directed to providing a method for estimating inclination of a vehicle or a road by detecting a motion of a vehicle and modeling and calculating the detected motion of the vehicle.

In the method for estimating inclination by modeling, a longitudinal acceleration sensor value obtained from a longitudinal acceleration sensor may be used. However, in the related art, a disturbance may occur in the longitudinal acceleration sensor value due to vibrations of a vehicle generated when the vehicle is stopped after braking, entering or exiting the vehicle in a stopped state, or slipstream generated by the passage of other vehicles.

Thus, the disturbance occurring in the longitudinal acceleration sensor value may adversely affect inclination estimation performance.

When state space modeling for estimating longitudinal acceleration is used, an estimated inclination value may converge with an actual inclination value while the vehicle is operating, such that an estimated inclination value may not updated when the vehicle is stopped.

An aspect of the present disclosure provides an apparatus and method for estimating inclination of a vehicle, capable of efficiently correcting disturbance of a longitudinal acceleration sensor value in a vehicle stop condition.

Another aspect of the present disclosure provides an apparatus and method for estimating inclination of a vehicle, capable of increasing the reliability of estimating the inclination of the vehicle in the process of stopping the vehicle.

Another aspect of the present disclosure provides an apparatus and method for estimating inclination of a vehicle, capable of estimating the inclination of the vehicle even when the vehicle is stopped.

According to an aspect of the present disclosure, there is provided an apparatus for estimating inclination of a vehicle, the apparatus including a vehicle information receiver configured to collect travel information of the vehicle including a wheel speed, a driving torque, and a longitudinal acceleration sensor value, a vehicle stop determinator configured to determine, based on the travel information received from the vehicle information receiver, whether the vehicle satisfies a vehicle stop condition, a disturbance corrector configured to correct disturbance of the longitudinal acceleration sensor value depending on whether the vehicle stop condition is satisfied, and an inclination estimator configured to estimate the inclination of the vehicle using a longitudinal acceleration input value corrected by the disturbance corrector.

In example embodiments, the vehicle stop condition may be set based on the wheel speed received from the vehicle information receiver, or based on the wheel speed and the driving torque received from the vehicle information receiver.

In example embodiments, the disturbance corrector may be configured to remove the longitudinal acceleration sensor value or to set a value obtained by lowering a proportion of the longitudinal acceleration sensor value as the longitudinal acceleration input value input to the inclination estimator, when the vehicle stop condition is satisfied.

In example embodiments, the travel information collected by the vehicle information receiver may further include a lateral speed and a yaw rate of the vehicle. The inclination estimator may be configured to estimate the inclination of the vehicle through a Kalman filter using the lateral speed, the yaw rate, and the longitudinal acceleration sensor value as input thereof.

The apparatus according to example embodiments may further include a weight setting unit configured to schedule, based on vehicle information received from the vehicle information receiver, a Q gain, a system error of the Kalman filter, depending on a travel situation. The weight setting unit may be configured to set a first Q gain when the vehicle stop condition is satisfied, and to set a second Q gain when a condition immediately before stopping, corresponding to a situation immediately before the vehicle is stopped, is satisfied.

In example embodiments, the disturbance corrector may be configured to remove the longitudinal acceleration sensor value or set a value obtained by lowering a proportion of the longitudinal acceleration sensor value as the longitudinal acceleration input value input to the inclination estimator, when the vehicle stop condition is satisfied, and to set the longitudinal acceleration sensor value as the longitudinal acceleration input value input to the inclination estimator, when the vehicle stop condition is not satisfied.

In example embodiments, the first Q gain may be set to have a value less than a value of the second Q gain.

In example embodiments, the weight setting unit may be configured to set a third Q gain, when a vehicle speed is in a setting range in an anti-lock braking system (ABS) operation state. The second Q gain may be set to have a value greater than a value of the first Q gain and less than a value of the third Q gain.

In example embodiments, a condition of the ABS operation state may include a first ABS condition and a second ABS condition having a vehicle speed higher than a vehicle speed of the first ABS condition. The weight setting unit may be configured to set a third Q gain, when the first ABS condition is satisfied, and to set a fourth Q gain, when the second ABS condition is satisfied. The fourth Q gain may be set to have a value greater than a value of the third Q gain.

The apparatus according to example embodiments may further include an estimated value initializer configured to initialize an estimated inclination value estimated by the inclination estimator, when a preset condition is satisfied. The estimated value initializer may be configured to initialize the estimated inclination value to inclination corresponding to the longitudinal acceleration sensor value or inclination corresponding to a value obtained by processing the longitudinal acceleration sensor value with a low-pass filter (LPF), when the vehicle stop condition is satisfied. The initialized estimated inclination value may be input to the inclination estimator.

In example embodiments, the estimated value initializer may be configured to process the longitudinal acceleration sensor value with the LPF, when a vehicle speed satisfies a low-speed condition having a preset value or less than the preset value.

In example embodiments, the estimated value initializer may be configured to initialize the estimated inclination value to inclination corresponding to the longitudinal acceleration sensor value, when a condition immediately before stopping is satisfied. The initialized estimated inclination value may be input to the inclination estimator.

In example embodiments, the estimated inclination value initialized by the estimated value initializer may be input to the disturbance corrector and used for disturbance correction.

According to another aspect of the present disclosure, there is provided a method for estimating inclination of a vehicle, the method including a vehicle information reception operation of receiving travel information of a vehicle including a wheel speed, a driving torque, and a longitudinal acceleration sensor value, a disturbance correction operation of determining, based on the travel information, whether the vehicle satisfies a vehicle stop condition and correcting disturbance of the longitudinal acceleration sensor value depending on whether the vehicle satisfies the vehicle stop condition, and an inclination estimation operation of estimating the inclination of the vehicle using a longitudinal acceleration input value corrected in the disturbance correction operation.

In example embodiments, the disturbance correction operation may include removing the longitudinal acceleration sensor value or setting a value obtained by lowering a proportion of the longitudinal acceleration sensor value as the longitudinal acceleration input value input to the inclination estimation operation, when the vehicle stop condition is satisfied.

The travel information received in the vehicle information reception operation may further include a lateral speed and a yaw rate of the vehicle. The inclination estimation operation may include estimating the inclination of the vehicle through a Kalman filter using the lateral speed, the yaw rate, and the longitudinal acceleration sensor value as input thereof.

The method according to example embodiments may further include a weight setting operation of scheduling, based on the vehicle information, a Q gain, a system error of the Kalman filter, depending on a travel situation. The weight setting operation may include setting a first Q gain when the vehicle stop condition is satisfied, and setting a second Q gain when a condition immediately before stopping, corresponding to a situation immediately before the vehicle is stopped, is satisfied. The first Q gain may be set to have a value less than a value of the second Q gain.

The method according to example embodiments may further include an estimated value initialization operation of initializing an estimated inclination value estimated in the inclination estimation operation, when a preset condition is satisfied. The estimated value initialization operation may include initializing the estimated inclination value to inclination corresponding to the longitudinal acceleration sensor value or inclination corresponding to a value obtained by processing the longitudinal acceleration sensor value with a low-pass filter (LPF), when the vehicle stop condition is satisfied. The initialized estimated inclination value may be input to the inclination estimation operation.

In example embodiments, the estimated value initialization operation may include initializing the estimated inclination value to inclination corresponding to the longitudinal acceleration sensor value, when a condition immediately before stopping is satisfied. The initialized estimated inclination value may be input to the inclination estimation operation.

According to another aspect of the present disclosure, there is provided a computer-readable storage medium recording a program for executing the method described in claim 14 on a computer.

According to example embodiments of the present disclosure having such a configuration, disturbance of a longitudinal acceleration sensor value may be efficiently corrected in a vehicle stop condition.

In addition, according to example embodiments of the present disclosure, the reliability of estimating inclination of a vehicle may be increased in the process of stopping the vehicle.

In addition, according to example embodiments of the present disclosure, inclination of a vehicle may be estimated even when the vehicle is stopped.

In addition, according to example embodiments of the present disclosure, the reliability of vehicle control, such as a traction control system (TCS), Idle Stop and Go (ISG), cruise control system, brake hold, or the like, may be increased.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF DRAWINGS

FIG. 1 is a schematic diagram illustrating a vehicle inclination estimation apparatus according to an example embodiment of the present disclosure.

FIG. 2 is a schematic diagram illustrating force acting on a vehicle traveling on a slope.

FIG. 3 is a flowchart illustrating a method for estimating inclination of a vehicle according to an example embodiment of the present disclosure.

FIG. 4 is a flowchart illustrating a weight setting operation illustrated in FIG. 3.

FIG. 5 is a flowchart illustrating a disturbance correction operation illustrated in FIG. 3.

FIG. 6 is a flowchart illustrating an estimated value initialization operation illustrated in FIG. 3.

FIG. 7 is a graph illustrating inclination over time illustrating a method for estimating inclination according to an example and a comparative example.

FIG. 8 is a block diagram of a computer device capable of fully or partially implementing a method for estimating inclination of a vehicle according to an example embodiment of the present disclosure.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments of the present disclosure, it will be understood that the present description is not intended to limit the invention(s) to those exemplary embodiments. On the contrary, the invention(s) is/are intended to cover not only the exemplary embodiments of the present disclosure, but also various alternatives, modifications, equivalents and other embodiments, which may be included within the spirit and scope of the invention as defined by the appended claims.

Hereinafter, example embodiments of the present disclosure will be described with reference to the accompanying drawings. The present disclosure may, however, be exemplified in many different forms and should not be construed as being limited to the specific example embodiments set forth herein.

As used herein, the singular forms “a,” “an,” and “the” are intended to include the plural forms as well, unless the context clearly indicates otherwise. The same reference numerals or reference numerals assigned in a similar manner throughout the specification refer to the same or corresponding components. In addition, the shapes and sizes of the components in the drawings may be exaggerated for clarity of description.

As used herein, a vehicle refers to various vehicles moving objects to be transported, such as people, animals, or objects, from a departure point to a destination. Such vehicles are not limited to vehicles travelling on roads or tracks.

Terms such as first, second, A, B, (a), (b), and the like may be used herein to describe components. However, the terms do not limit a sequence, size, importance, and the like of components, and are used only to distinguish a component from another component.

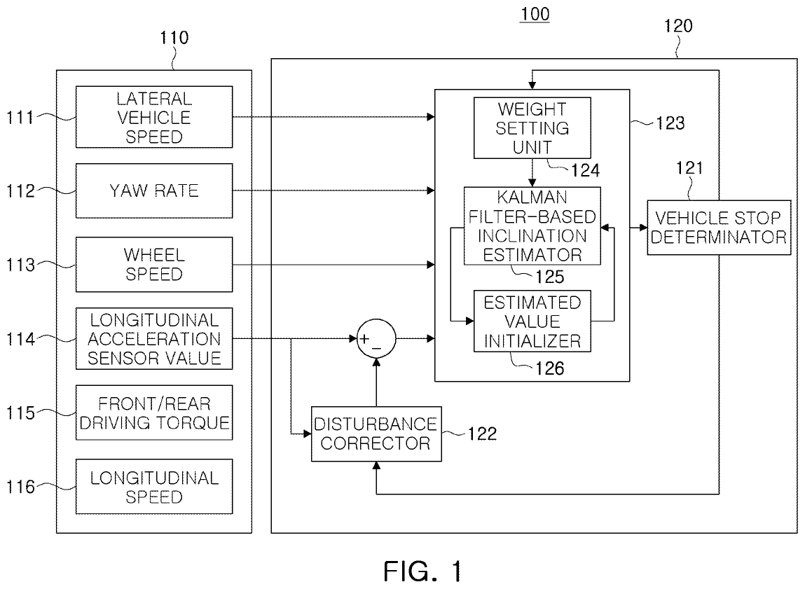

FIG. 1 is a schematic diagram illustrating a vehicle inclination estimation apparatus 100 according to an example embodiment of the present disclosure.

Referring to FIG. 1, the vehicle inclination estimation apparatus 100 may include a vehicle information receiver 110 and a controller, i.e., a computing device, which includes a vehicle stop determinator 121, a disturbance corrector 122, and an inclination estimator 125. In addition, the vehicle inclination estimation apparatus 100 according to an example embodiment may further include a weight setting unit 124 and an estimated value initializer 126. An inclination estimator 120 may include at least one of a vehicle stop determinator 121, a disturbance corrector 122, an inclination estimator 125, a weight setting unit 124, and an estimated value initializer 126.

The vehicle information receiver 110 may receive travel information measured or calculated by various sensors provided in a vehicle. The vehicle information receiver 110 may directly acquire information from the sensors (e.g., a lateral vehicle speed sensor, a yaw rate sensor, a wheel speed sensor, an acceleration sensor, a torque sensor, a longitudinal vehicle speed sensors, etc.) provided in the vehicle, or may receive information through a control unit (for example, a vehicle control unit (VCU) or the like), connected to respective sensors to collect information. The vehicle information receiver 110 may receive a lateral speed 111, a yaw rate 112, a wheel speed 113 of each wheel, longitudinal acceleration 114, driving torque 115 of front/rear wheels, and a longitudinal speed 116 of the vehicle. The longitudinal acceleration 114 may be a value measured by a longitudinal acceleration sensor, and the longitudinal acceleration 114, measured by the longitudinal acceleration sensor, may be represented as a longitudinal acceleration sensor value 114 to avoid confusion with similar terms.

The vehicle stop determinator 121 may determine, based on the travel information received from the vehicle information receiver 110, whether the vehicle satisfies a vehicle stop condition.

The vehicle stop condition may be set based on the wheel speed 113 of the vehicle received from the vehicle information receiver 110. The vehicle stop condition may also be set based on the wheel speed 113 and the driving torque 115 of the vehicle.

As an example, the vehicle stop condition may be set as a case in which the wheel speed 113 of each of all wheels is less than a first speed (for example, 0.15 m/s) for a first period of time (for example, 1 second), and no driving torque 115 is applied to the wheels of the vehicle. However, the vehicle stop condition is not limited thereto, and may be changed in various manners in consideration of performance of the vehicle and properties of various sensors such as a longitudinal acceleration sensor and the like. As used herein, the “vehicle stop condition” may include a case in which the vehicle slightly moves in a state in which no driving torque 115 is not applied to the wheels as well as in a state in which the vehicle is completely stopped. For example, the “vehicle stop condition” may include a case in which the vehicle is slightly pushed on a slope.

In a stopped state after braking, vibrations of the vehicle may occur, and shaking or vibrations of the vehicle may also occur due to external factors. For example, shaking or vibration of the vehicle may occur due to slipstream induced by passengers entering or exiting the vehicle or other vehicles travelling nearby.

Thus, disturbance may occur in the longitudinal acceleration sensor value 114 when the vehicle stop condition is satisfied. When inclination estimation is performed based on the longitudinal acceleration sensor value 114, the disturbance of the longitudinal acceleration sensor value 114 may act as noise and adversely affect inclination estimation performance.

The disturbance corrector 122 may correct the disturbance of the longitudinal acceleration sensor value 114 depending on whether the vehicle stop condition is satisfied. That is, in the vehicle stop condition, a lot of noise may occur in the longitudinal acceleration sensor value 114 due to vibrations or shaking of the vehicle. Accordingly, when inclination estimation is performed, the influence of the longitudinal acceleration sensor value 114 may be reduced by correcting the disturbance of the vehicle stop condition.

The inclination estimator 125 may estimate an inclination of the vehicle using a longitudinal acceleration input value.

When a vehicle is stopped on a road with an inclination angle α, a longitudinal acceleration aₓ of the vehicle by gravity may be represented as g sin α. Accordingly, the inclination of the vehicle may be estimated through the longitudinal acceleration sensor value 114. A unit of the longitudinal acceleration sensor value 114 may be meter per second squared (m/s²), and the inclination, estimated using the longitudinal acceleration sensor value 114, may have a unit the same as that of the longitudinal acceleration sensor value 114. For ease of description, in the detailed description and claims, the inclination is described as having a unit of m/s², in the same manner as a unit of an acceleration.

The inclination of the vehicle may be estimated using the longitudinal acceleration input value corrected by the disturbance corrector 122. The inclination of the vehicle may have a value substantially the same as or similar to that of inclination of the road.

The inclination estimator 125 may estimate the inclination of the vehicle using the longitudinal acceleration input value corrected by the disturbance corrector 122. When noise of the longitudinal acceleration sensor occurring in the vehicle stop condition is reduced or removed, the reliability of inclination estimation may be increased and settling time of an estimated inclination value may be reduced.

To this end, when the vehicle stop condition is satisfied, the disturbance corrector 122 may set, as the longitudinal acceleration input value input to the inclination estimator 125, a value obtained by removing the longitudinal acceleration sensor value 114 or a value obtained by lowering a proportion of the longitudinal acceleration sensor value 114.

When the vehicle stop condition is satisfied, the disturbance corrector 122 may consider that the longitudinal acceleration sensor value 114 includes a lot of noise, exclude the longitudinal acceleration sensor value 114, and set an estimated inclination value estimated in a previous operation (time) as the longitudinal acceleration input value.

Alternatively, when the vehicle stop condition is satisfied, the disturbance corrector 122 may set, as the longitudinal acceleration input value, a value obtained by lowering the proportion of the longitudinal acceleration sensor value 114 and increasing a proportion of the estimated inclination value estimated in the previous operation. For example, when the vehicle stop condition is satisfied, the longitudinal acceleration input value, input to the inclination estimator 125, may have a value obtained by setting a ratio of the longitudinal acceleration sensor value 114 to 0.2, and setting a ratio of the estimated inclination value estimated in the previous operation to 0.8.

In addition, when the vehicle stop condition is not satisfied, the disturbance corrector 122 may set the longitudinal acceleration sensor value 114 as the longitudinal acceleration input value input to the inclination estimator 125. That is, when the vehicle stop condition is not satisfied, the disturbance corrector 122 may not correct disturbance with respect to the longitudinal acceleration sensor value 114.

The inclination estimator 125 may estimate the inclination through a filter which is configured for modeling a state space. For example, the inclination estimator 125 may estimate the inclination of the vehicle through a Kalman filter 123. The Kalman filter 123 according to an example embodiment may include an inclination estimator 125, a weight setting unit 124, and an estimated value initializer 126.

The Kalman filter may be an estimation technique for finding a state variable of a system using a probabilistic model and a measured value of a target system.

The Kalman filter may include a prediction process (prediction step) and an estimation process (correction step). Equations 1 and 2 relate to the prediction process, and Equations 3 to 5 relate to the estimation process.

$${\hat{x}}_{k}^{-} = A {\hat{x}}_{k - 1} + B {u}_{k} \qquad [ Equation 1 ]$$

$${P}_{k}^{-} = A {P}_{k - 1} {A}^{T} + Q \qquad [ Equation 2 ]$$

In Equation 1, “x” may be a state matrix representing a state variable to be optimized through a Kalman filter, and “A” may be a system matrix. “B” may be a control matrix, and “u” may be an input matrix. In Equation 2, “P” may be an error covariance, and “Q” may be a system error (system noise). The “k” is an integer and the “T” means transpose of a matrix.

The prediction operation may use system model variables “A” and “Q” to receive a last estimated value “x” and an error covariance “P” as inputs, and may output predicted values (estimated values) “x” and “P” as final results. The predicted values “x” and “P” may be used in the estimation process.

$${K}_{k} = {P}_{k}^{-} {{H}^{T} ( H {P}_{k}^{-} {H}^{T} + R )}^{- 1} \qquad [ Equation 3 ]$$

$${\hat{x}}_{k} = {\hat{x}}_{k}^{-} + {K}_{k} ( {z}_{k} - H {\hat{x}}_{k}^{-} ) \qquad [ Equation 4 ]$$

$${P}_{k} = ( I - {K}_{k} H ) {P}_{k}^{-} \qquad [ Equation 5 ]$$

In Equations 3 to 5, “K” may be a Kalman gain, “H” may be a filter model, and “R” may be a sensor error (sensor noise). In Equation 4, “z” may be a measured value.

The estimation process may receive predicted values “x” and “P,” and measured value “z,” and may output the estimated value “x” and error covariance “P” using filter model “H,” and sensor error “R.”

The above-described Kalman filter may be used for inclination estimation, which will be described in more detail.

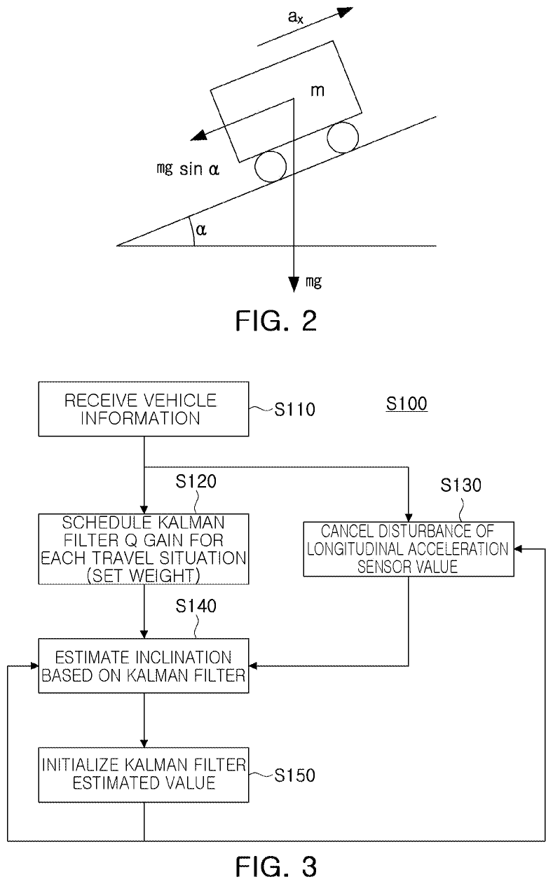

FIG. 2 is a schematic diagram illustrating force acting on a vehicle traveling on a slope. A longitudinal direction of the vehicle may correspond to a length direction of the vehicle, a lateral direction of the vehicle may correspond to a left-to-right direction of the vehicle, and a vertical direction of the vehicle may correspond to a height direction of the vehicle. In addition, motion rotating with respect to the longitudinal direction of the vehicle may be referred to as roll, motion rotating with respect to the lateral direction of the vehicle may be referred to as pitch, and motion rotating with respect to the height direction of the vehicle may be referred to as yaw.

Referring to FIG. 2, a longitudinal acceleration sensor value axm detected by a longitudinal acceleration sensor of the vehicle may be obtained using Equation 6.

$${a}_{x , m} = {a}_{x} + g sin ( α + θ ) - {V}_{y} φ \qquad [ Equation 6 ]$$

In Equation 6, “aₓ” may be longitudinal acceleration of the vehicle, “g” may be a gravitational acceleration, “α” may be an inclination angle of a road on which the vehicle is travelling, “θ” may be a pitch angle, “V_{y}” may be a lateral speed of the vehicle, and “φ” may be a yaw rate.

When Equation 6 is designed as a state space, Equation 6 may be represented by Equations 7 to 9 below.

$$\dot{x} = [ \begin{matrix}0 & - g \\ 0 & 0\end{matrix} ] x + [ \begin{matrix}1 & 1 \\ 0 & 0\end{matrix} ] u \qquad [ Equation 7 ]$$

$$x = [ \begin{matrix}{V}_{x} \\ sin ( α + θ )\end{matrix} ] \qquad [ Equation 8 ]$$

$$u = [ \begin{matrix}{a}_{x , m} & {V}_{y} φ\end{matrix} ] \qquad [ Equation 9 ]$$

In Equation 7,

$$[ \begin{matrix}0 & - g \\ 0 & 0\end{matrix} ]$$

may correspond to system matrix “A” of Equation 1, and

$$[ \begin{matrix}1 & 1 \\ 0 & 0\end{matrix} ]$$

of Equation 7 may correspond to control matrix “B” of Equation 1. In Equations 7 and 8, “x” may be a state matrix. In Equations 7 and 9, “u” may be an input matrix. Input matrix “u” of the Kalman filter may be set as a longitudinal acceleration sensor value a_{x,m}, and a product of a lateral speed V_{y} and a yaw rate φ of the vehicle. In an example embodiment, a measured value z of the Kalman filter may be a vehicle speed based on wheel speed, and a predicted value (estimated value) may be a longitudinal acceleration sensor value. Inclination of the vehicle may be estimated from a predicted (estimated) longitudinal acceleration sensor value.

In an example embodiment, travel information used for the Kalman filter 123 may include wheel speed 113, a longitudinal acceleration sensor value 114, a lateral speed 111 of the vehicle, and a yaw rate 112 of the vehicle, and the travel information may be received from the vehicle information receiver 110. The inclination estimator 125 may estimate the inclination of the vehicle through the Kalman filter 123 using the wheel speed 113, the lateral speed 111, the yaw rate 112, and the longitudinal acceleration sensor value 114. The wheel speed 113 may be input to the Kalman filter as a measured value, and the longitudinal acceleration sensor value 114 and the lateral speed 111 and yaw rate 112 of the vehicle may be input to the Kalman filter as an input matrix. The longitudinal acceleration sensor value 114 may correspond to a predicted value of the Kalman filter.

The weight setting unit 124 may schedule, based on the vehicle information (e.g., a wheel speed, a longitudinal acceleration sensor value, etc.) received from the vehicle information receiver 110, a Q gain, a system error of the Kalman filter, depending on a travel situation (e.g., a vehicle speed, an ABS situation, etc.). That is, the weight setting unit 124 may set a value of the Q gain depending on the travel situation. Accordingly, in the Kalman filter used for the inclination estimator 125, weights of a measured value (that is, wheel speed) and a predicted value (that is, a longitudinal acceleration sensor value) may be changed.

In general, in the Kalman filter, when the Q gain (Q value) increases, the weight of the measured value (that is, wheel speed) may increase and the weight of the predicted value (that is, a longitudinal acceleration sensor value) may decrease. Conversely, when the Q gain (Q value) decreases, the weight of the measured value (that is, wheel speed) may increase and the weight of the predicted value (that is, a longitudinal acceleration sensor value) may increase.

The weight setting unit 124 may set a first Q gain when the vehicle stop condition is satisfied, and may set a second Q gain when a condition immediately before stopping, corresponding to a situation immediately before the vehicle is stopped, is satisfied.

As described above, in the vehicle stop condition, a lot of noise may occur in the longitudinal acceleration sensor value 114 due to a change in load movement of the vehicle and/or excitation of the vehicle by a spring. When the vehicle stop condition is satisfied, the disturbance corrector 122 may remove the longitudinal acceleration sensor value or may set a value obtained by lowering a proportion of the longitudinal acceleration sensor value as the longitudinal acceleration input value input to the inclination estimator 125. Accordingly, in the vehicle stop condition, the longitudinal acceleration input value input to the inclination estimator 125 may not reflect the longitudinal acceleration sensor value in which noise occurs or may have a small proportion of reflection of the longitudinal acceleration sensor value. In the vehicle stop condition, the longitudinal acceleration input value from which disturbance has been removed by the disturbance corrector 122 may be input to the Kalman filter-based inclination estimator 125, such that the reliability of the longitudinal acceleration sensor value (an input value from which disturbance has been removed), a predicted value, may be higher than that of the longitudinal acceleration sensor value before disturbance is removed.

Thus, in order to set the longitudinal acceleration sensor value, in which disturbance is cancelled by the disturbance corrector 122, as the longitudinal acceleration input value, and to allow the Kalman filter to actively use the longitudinal acceleration sensor value (predicted value) from which disturbance is removed, a value of the first Q gain may be lowered.

When the condition immediately before stopping, corresponding to a condition immediately before the vehicle is stopped, is satisfied, the vehicle may not be in a stopped state, such that vibrations or shaking may be less likely to occur due to stopping. That is, the condition immediately before stopping may be a state immediately before disturbance occurs in the longitudinal acceleration sensor value, such that the longitudinal acceleration sensor value may have high reliability. Accordingly, in order to increase a weight of the longitudinal acceleration sensor value (prediction value) having high reliability, a value of the second Q gain may be lowered.

The condition immediately before stopping may be a state in which a vehicle speed is less than a second speed (for example, 0.15 m/s) and a differential value of the longitudinal acceleration sensor value is less than a preset value (for example, 0.04) for a period of time less than a second period of time (for example, 1 second). However, the condition immediately before stopping is not limited thereto, and various changes may be made in consideration of vehicle performance and properties of various sensors such as a longitudinal acceleration sensor and the like.

The first Q gain of the vehicle stop condition may be set to have a value less than a value of the second Q gain of the vehicle stop condition. In this case, in the vehicle stop condition without wheel speed, the longitudinal acceleration input value in which disturbance is cancelled may be actively used, and the longitudinal acceleration sensor value (predicted value) may be allowed to rapidly approach to an estimated value of the Kalman filter. In addition, the second Q gain may be set to have a value greater than that of the first Q gain, thereby increasing a ratio of the longitudinal acceleration sensor value, as compared to the vehicle stop condition. Accordingly, in the process of changing the estimated inclination value from the condition immediately before stopping to the vehicle stop condition, a change rate of the estimated inclination value may be reduced.

The weight setting unit 124 may set the Q gain in an anti-lock braking system (ABS) operation state. For example, when the vehicle speed is in a setting range, the weight setting unit 124 may set the third Q gain.

The rotation of the wheel may be restricted in the ABS operation state. Thus, the reliability of the estimated inclination value may decrease when the wheel speed is input to the Kalman filter. That is, in the ABS operation state in which the rotation of the wheel is restricted, the correction performance of the Kalman filter may be adversely affected. Accordingly, a high level of filtering may be required to increase the reliability of the estimated inclination value. In the ABS operation state, the Q gain may be increased, thereby increasing the weight of the wheel speed (measured value) and reducing the weight of the predicted value (longitudinal acceleration sensor value). In an ABS operation condition, the change rate of the estimated inclination value may be reduced by increasing the Q gain. A third Q gain of the ABS operation condition may be set to have a value greater than that of the first Q gain of the vehicle stop condition or the second Q gain of the condition immediately before stopping.

The ABS operation condition may include a first ABS condition and a second ABS condition having a vehicle speed higher than a vehicle speed of the first ABS condition. The weight setting unit 124 may set the third Q gain when the first ABS condition is satisfied, and may set the fourth Q gain when the second ABS condition is satisfied.

The first ABS condition may correspond to a low-speed ABS condition, and may correspond to the second ABS condition. The second ABS condition may have a vehicle speed higher than that of the first ABS condition, thereby further increasing an adverse effect on the correction performance of the Kalman filter, as compared to the first ABS condition. Accordingly, as compared to the first ABS condition, a higher level of filtering may be required to increase the reliability of the estimated inclination value. Considering such a point, the fourth Q gain of the second ABS condition may be set to have a value greater than a value of the third Q gain of the first ABS condition.

For example, the first ABS condition may be set as a case in which a period of time elapsed from when ABS control is released is less than a third period of time (for example, 0.8 seconds) and a vehicle speed is lower than a third speed (for example, 1 m/s). The second ABS condition may be set as a case in which a period of time elapsed from when ABS control is released is less than a fourth period of time (for example, 0.5 second) and a vehicle speed is higher than a fourth speed (for example, 3 m/s). However, the ABS condition is not limited thereto and may be changed in various manners in consideration of performance of the vehicle and properties of various sensors, and the like. In addition, the condition of the ABS operation state may be set to have only one section, and may be divided into three or more sections.

The estimated value initializer 126 may initialize the estimated inclination value estimated by the inclination estimator 125, when a preset condition is satisfied.

The estimation process of the Kalman filter may output a new estimated value using the predicted value (estimated value) and the measured value of the prediction process. Accordingly, due to the properties of the Kalman filter, the estimated value may converge into a true value only when a system operates. That is, the system may not operate in the stopping state, such that the estimated inclination value may not converge into an actual value (true value) of the inclination. When a difference between the estimated inclination value and the actual inclination value increases, the vehicle may not be held with appropriate brake pressure when stopped on a slope, and appropriate engine torque may not be applied when the vehicle starts from the slope.

In an example embodiment, in order to resolve such an issue, when the vehicle stop condition is satisfied, the estimated inclination value of the Kalman filter may be initialized to a preset value. For example, the estimated value initializer 126 may initialize the estimated inclination value of the Kalman filter to inclination corresponding to the longitudinal acceleration sensor value or inclination corresponding to a value obtained by processing the longitudinal acceleration sensor value with a low-pass filter (LPF). The initialized estimated inclination value may be input to the inclination estimator 125. That is, according to an example embodiment, an estimated inclination value of a previous operation (time) may be initialized to a longitudinal acceleration sensor value or a value obtained by processing the longitudinal acceleration sensor value with the LPF by the estimated value initializer 126, and the initialized estimated inclination value may be input to inclination estimator 125 to be used for inclination estimation of a next operation (time).

A wheel speed sensor, using a toothed wheel, may have reduced reliability due to back lash or the like, when the vehicle has a significantly low-speed. In addition, vibrations of the vehicle may occur due to a spring and/or a damper when the vehicle is stopped after braking. In view of such a point, when a low-speed condition in which a vehicle speed has a value equal to or less than a preset value is satisfied, the longitudinal acceleration sensor value may be processed with the LPF. The LPF may attenuate a signal having a frequency higher than or equal to a specific cutoff frequency, thereby allowing only a signal having a frequency lower than or equal to a cutoff frequency. In the low-speed condition, the longitudinal acceleration sensor value may be processed with the LPF, thereby increasing the reliability of the longitudinal acceleration sensor value.

For example, in a low-speed condition, the vehicle speed may be lower than a fifth speed (for example, 0.65 m/s). However, the low-speed condition is not limited thereto, and various changes may be made in consideration of performance of the vehicle and properties of various sensors such as a wheel speed sensor and the like.

Thus, when the low-speed condition and the vehicle stop condition are satisfied, the estimated inclination value may be initialized to a value obtained by processing the longitudinal acceleration sensor value with the LPF by the estimated value initializer 126. The initialized estimated inclination value may be input to the inclination estimator 125.

In addition, when the condition immediately before stopping is satisfied, the estimated value initializer 126 may initialize the estimated inclination value to inclination corresponding to the longitudinal acceleration sensor value. The initialized estimated inclination value may be input to the inclination estimator 125.

The estimated inclination value initialized by the estimated value initializer 126 may be input to the disturbance corrector 122 to be used for disturbance correction.

When the vehicle does not satisfy the vehicle stop condition or the condition immediately before stopping, the system may operate normally, such that inclination estimation may be performed normally. In this case, the estimated value initializer 126 may not initialize the estimated inclination value estimated by the inclination estimator 125. Accordingly, the estimated inclination value estimated by the inclination estimator 125 may be input again to the inclination estimator 125 to be used for inclination estimation in a next operation.

FIG. 3 is a flowchart illustrating a vehicle inclination estimation method S100 according to an example embodiment of the present disclosure.

Referring to FIG. 3, the vehicle inclination estimation method S100 according to an example embodiment may include a vehicle information reception operation S110, a disturbance correction operation (S130), and inclination estimation operation (S140). In addition, the vehicle inclination estimation method S100 according to an example embodiment may include at least one of a weight setting operation (S120) and an estimated value initialization operation (S150).

The vehicle inclination estimation method S100 according to an example embodiment may be the same as the vehicle inclination estimation apparatus 100 described with reference to FIGS. 1 and 2 implemented as a method. Thus, the above description of the inclination estimation apparatus 100 may be applied to the vehicle inclination estimation method S100. Although it is described above that the inclination estimation apparatus 100 includes the vehicle stop determinator 121, determination as to whether to stop a vehicle may be performed individually in the disturbance correction operation (S130), the weight setting operation (S120), and the estimated value initialization operation (S150).

In the vehicle information reception operation S110, information measured or calculated from various sensors provided in the vehicle may be received. In the vehicle information reception operation S110, at least a portion of vehicle information such as a lateral speed 111, a yaw rate 112, a wheel speed 113 of each wheel, a longitudinal acceleration sensor value 114, driving torque 115 of the front/rear wheels, and a longitudinal speed 116 the vehicle may be received.

In the disturbance correction operation (S130), whether the vehicle satisfies a vehicle stop condition may be determined based on travel information, and disturbance of the longitudinal acceleration sensor value may be corrected depending on whether the vehicle satisfies the vehicle stop condition. In the disturbance correction operation (S130), when the vehicle stop condition is satisfied, the longitudinal acceleration sensor value may be removed or a value obtained by lowering a proportion of the longitudinal acceleration sensor value may be set as a longitudinal acceleration input value input to the inclination estimation operation (S140).

In the weight setting operation (S120), a Q gain, a system error of a Kalman filter, may be scheduled, based on the vehicle information, depending on a travel situation. In the weight setting operation (S120), the Q gain may be set in consideration of whether the vehicle satisfies the vehicle stop condition, whether the vehicle satisfies a condition immediately before stopping, whether the vehicle satisfies an ABS condition, and the like. The Q gain set in the weight setting operation (S120) may be input to the inclination estimation operation (S140). The Q gain may be used when weights of a measured value (that is, wheel speed) and a predicted value (that is, a longitudinal acceleration sensor value) is changed in the Kalman filter used in the inclination estimation operation (S140).

In the inclination estimation operation (S140), inclination of the vehicle may be estimated using the longitudinal acceleration input value corrected in the disturbance correction operation (S130). In the inclination estimation operation (S140), the inclination of the vehicle may be estimated through the Kalman filter using the lateral speed, yaw rate, and longitudinal acceleration sensor value. In the inclination estimation operation (S140), the Q gain set in the weight setting operation (S120) may be used for the Kalman filter. The inclination estimation performed through the Kalman filter may have a configuration substantially the same as that performed by the inclination estimator 125 of the inclination estimation apparatus 100 described above.

In the estimated value initialization operation (S150), the estimated inclination value estimated in the inclination estimation operation (S140) may be initialized when a preset condition is satisfied. The estimated inclination value estimated in the Kalman filter-based inclination estimation operation (S140) may be input to the estimated value initialization operation (S150). In the estimated value initialization operation (S150), when the preset condition is satisfied, the estimated inclination value may be initialized, and then the initialized estimated inclination value may be input to the inclination estimation operation (S140). In the inclination estimation operation (S140), Kalman filter-based inclination estimation may be performed using the initialized estimated inclination value. The estimated value initialization operation (S150) may allow inclination estimation to be performed even in the vehicle stop condition in which a system is in a stopped state.

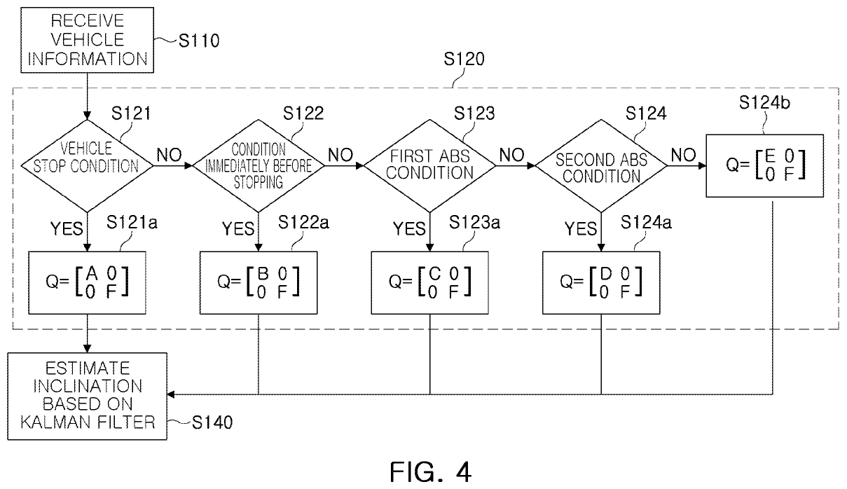

Hereinafter, with reference to FIGS. 4 to 6, the weight setting operation (S120), the disturbance correction operation (S130), and the estimated value initialization operation (S150) will be described in more detail.

FIG. 4 is a flowchart illustrating the weight setting operation (S120) illustrated in FIG. 3.

Referring to FIG. 4, in the weight setting operation (S120), a Q gain, a system error of a Kalman filter, may be scheduled depending on a travel situation, based on the vehicle information input in the vehicle information reception operation (S110). In the weight setting operation (S120), a value of the Q gain may be set depending on a travel situation. Accordingly, in the Kalman filter used in the inclination estimation operation (S140), weights of a measured value (that is, wheel speed) and a predicted value (that is, a longitudinal acceleration sensor value) may be changed.

The Q gain may be formed of a 2×2 (two by two) matrix. In a Q gain matrix of FIG. 4, A, B, C, D, and E values indicated in row 1 and column 1 may determine the value of the Q gain. When the A, B, C, D, and E values increase, the value of the Q gain may increase. When the A, B, C, D, and E values decrease, the value of the Q gain may decrease. In addition, in the Q gain matrix of FIG. 4, the F value of row 2 and column 2 may be a constant value due to filter noise, and may be set as the same value under all conditions. Accordingly, the F value may not affect the value of the Q gain.

In general, in the Kalman filter, when the Q gain (Q value) increases, the weight of the measured value (that is, wheel speed) may increase, and the weight of the predicted value (that is, a longitudinal acceleration sensor value) may decrease. Conversely, when the Q gain (Q value) decreases, the weight of the measured value (that is, wheel speed) may increase, and the weight of the predicted value (that is, a longitudinal acceleration sensor value) may increase.

In a vehicle stop condition, a lot of noise may occur in the longitudinal acceleration sensor value due to a change in load movement of a vehicle and/or excitation of the vehicle by a spring. Accordingly, as will be described below, in the disturbance correction operation (S130), when the vehicle stop condition is satisfied, the longitudinal acceleration sensor value may be removed or a value obtained by lowering the weight of the longitudinal acceleration sensor value may be set as a longitudinal acceleration input value, input to the inclination estimation operation (S140).

When the vehicle stop condition is satisfied (S121), a first Q gain may be set (S121a). In the vehicle stop condition, the longitudinal acceleration input value, input to the inclination estimation operation (S140), may not reflect the longitudinal acceleration sensor value in which noise occurs or may have a small proportion of reflection of the longitudinal acceleration sensor value. Accordingly, to allow the Kalman filter to actively use the longitudinal acceleration sensor value (predicted value) from which disturbance is removed, a value of the first Q gain may be lowered. As an example, the vehicle stop condition may be set as a case in which a wheel speed 113 of each of all wheels is less than a first speed (for example, 0.15 m/s) for a first period of time (for example, 1 second), and no driving torque 115 is applied to the wheels.

When the condition immediately before the vehicle is stopped is satisfied (S122), a second Q gain may be set (S122a). The condition immediately before stopping may be a state immediately before disturbance occurs in the longitudinal acceleration sensor value, such that the longitudinal acceleration sensor value may have high reliability. Accordingly, in order to increase a weight of the longitudinal acceleration sensor value (prediction value) having high reliability, a value of the second Q gain may be lowered. As an example, the condition immediately before stopping may be a state in which a vehicle speed is less than a second speed (for example, 0.15 m/s) and a differential value of the longitudinal acceleration sensor value is less than a preset value (for example, 0.04) for a period of time less than a second period of time (for example, 1 second).

The first Q gain of the vehicle stop condition may be set to have a value less than a value of the second Q gain of the vehicle stop condition. In this case, in the vehicle stop condition without wheel speed, the longitudinal acceleration input value in which disturbance is cancelled may be actively used, and the longitudinal acceleration sensor value (predicted value) may be allowed to rapidly approach to an estimated value of the Kalman filter. In addition, the second Q gain may be set to have a value greater than that of the first Q gain, thereby increasing a ratio of the longitudinal acceleration sensor value, as compared to the vehicle stop condition. Accordingly, in the process of changing an estimated inclination value from the condition immediately before stopping to the vehicle stop condition, a change rate of the estimated inclination value may be reduced.

The Q gain may be set even in an ABS operation state. A condition of the ABS operation state may include a first ABS condition and a second ABS condition having a vehicle speed higher than a vehicle speed of the first ABS condition.

When the first ABS condition, a low-speed ABS condition, is satisfied (S123), a third Q gain may be set (S123a). When the second ABS condition, a high-speed ABS condition, is satisfied (S124), a fourth Q gain may be set (S124a). The first ABS condition may correspond to the low-speed ABS condition, and may correspond to the second ABS condition.

The rotation of a wheel may be restricted in the ABS operation state. Thus, the reliability of the estimated inclination value may decrease when wheel speed is input to the Kalman filter. That is, in the ABS operation state in which the rotation of the wheel is restricted, the correction performance of the Kalman filter may be adversely affected. Accordingly, a high level of filtering may be required to increase the reliability of the estimated inclination value. In the ABS operation state, the Q gain may be increased, thereby increasing a weight of the wheel speed (measured value) and reducing the weight of the predicted value (longitudinal acceleration sensor value). In an ABS operation condition, the change rate of the estimated inclination value may be reduced by increasing the Q gain. A third Q gain and a fourth Q gain of the ABS operation condition may be set to have a value greater than that of the first Q gain of the vehicle stop condition or the second Q gain of the condition immediately before stopping.

The second ABS condition may have a vehicle speed higher than that of the first ABS condition, thereby further increasing an adverse effect on the correction performance of the Kalman filter, as compared to the first ABS condition. Accordingly, as compared to the first ABS condition, a higher level of filtering may be required to increase the reliability of the estimated inclination value. Considering such a point, the fourth Q gain of the second ABS condition may be set to have a value greater than a value of the third Q gain of the first ABS condition.

For example, the first ABS condition may be set as a case in which a period of time elapsed from when ABS control is released is less than a third period of time (for example, 0.8 seconds) and a vehicle speed is lower than a third speed (for example, 1 m/s). The second ABS condition may be set as a case in which a period of time elapsed from when ABS control is released is less than a fourth period of time (for example, 0.5 second) and a vehicle speed is higher than a fourth speed (for example, 3 m/s).

When none of the vehicle stop condition (S121), the condition immediately before stopping (S122), the first ABS condition (S123) is satisfied, and the second ABS condition (S124) is not satisfied, a fifth Q gain may be set (S124b).

A value of the fourth Q gain (S124a) may be greater than a value of the third Q gain (S123a). The value of the third Q gain (S123a) may be greater than a value of the second Q gain (S122a). The value of the second Q gain (S122a) may be greater than a value of the first Q gain (S121a). A value of the fifth Q gain (S124b) may be greater than the value of the first Q gain (S121a). For example, in FIG. 4, A of the first Q gain may be set to 1, B of the second Q gain may be set to 100, C of the third Q gain may be set to 200, D of the fourth Q gain may be set to 400, and E of the fifth Q gain may be set to 10. However, the above-described values of the first to fifth Q gains are simply presented for comparison, and various changes may be made when applied to an actual system.

Each Q gain, set depending on a travel situation in the weight setting operation (S120), may be input to the inclination estimation operation (S140). In the inclination estimation operation (S140), inclination of the vehicle may be estimated through a Kalman filter using a lateral speed, a yaw rate, and a longitudinal acceleration sensor value.

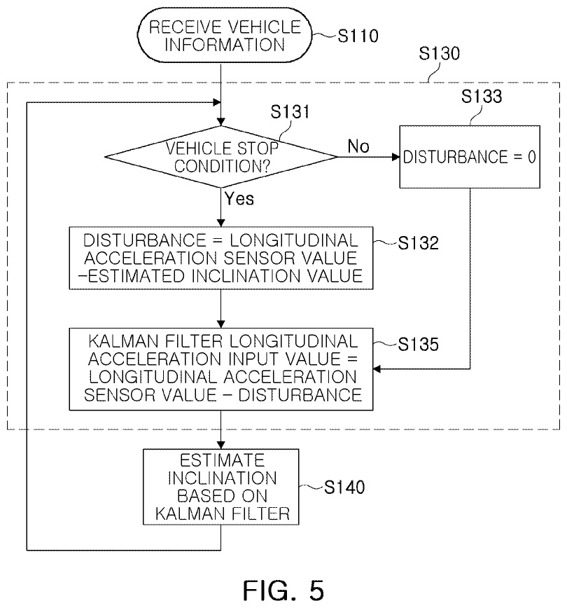

FIG. 5 is a flowchart illustrating the disturbance correction operation S130 illustrated in FIG. 3.

Referring to FIG. 5, in the disturbance correction operation (S130), disturbance of a longitudinal acceleration sensor value may be corrected based on vehicle information input in the vehicle information reception operation (S110).

In the disturbance correction operation (S130), it may be determined whether a vehicle stop condition is satisfied (S131), and a value, obtained by subtracting an estimated inclination value from the longitudinal acceleration sensor value, may be set as disturbance, when the vehicle stop condition is satisfied (S132). Here, the estimated inclination value may be an estimated inclination value estimated in the inclination estimation operation (S140), or may be an estimated inclination value initialized in the estimated value initialization operation (S150) when the estimated value initialization operation (S150) is performed. When the vehicle stop condition is not satisfied, the disturbance may be set to 0 (zero).

Subsequently, a longitudinal acceleration input value, input to the Kalman filter-based inclination estimation operation (S140), may be set (S135). Here, the longitudinal acceleration input value, input to the Kalman filter, may be set as a value from which disturbance in the vehicle stop condition is removed or reduced. For example, the longitudinal acceleration input value may be set as a value obtained by subtracting disturbance from the longitudinal acceleration sensor value. Here, the disturbance may be a value set in operations S132 and S133.

Accordingly, when the vehicle stop condition is satisfied, the longitudinal acceleration input value, input to the Kalman filter, may be calculated by subtracting the longitudinal acceleration sensor value from the disturbance in operation S132 (that is, the longitudinal acceleration sensor value-the estimated inclination value). That is, when the vehicle stop condition is satisfied, the longitudinal acceleration input value, calculated in operation S135, may be the estimated inclination value.

In addition, when the vehicle stop condition is not satisfied, the longitudinal acceleration input value, input to the Kalman filter, may be calculated by subtracting the disturbance (that is, 0) in operation S133 from the longitudinal acceleration sensor value. That is, when the vehicle stop condition is not satisfied, the longitudinal acceleration input value, calculated in operation S135, may be the longitudinal acceleration sensor value.

Thus, in the disturbance correction operation (S130), when the vehicle stop condition is satisfied, inclination input value in which disturbance is cancelled may be input to the inclination estimation operation (S140) instead of the longitudinal acceleration sensor value including a lot of noise. That is, when the vehicle stop condition is satisfied, an estimated inclination value estimated in a previous operation (time) or an estimated inclination value initialized in the estimation value initialization operation (S150) may be input to the inclination estimation operation (S140), as the inclination input value.

Conversely, when the vehicle stop condition is not satisfied, the longitudinal acceleration sensor value may be input to the inclination estimation operation (S140).

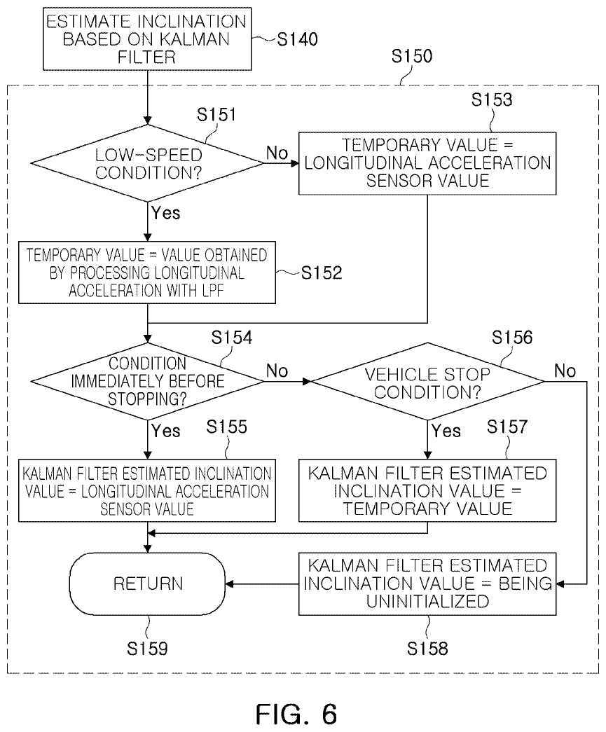

FIG. 6 is a flowchart illustrating the estimated value initialization operation S150 illustrated in FIG. 3.

Referring to FIG. 6, in the estimation value initialization operation (S150), an estimated inclination value estimated in the inclination estimation operation (S140) may be initialized when a preset condition is satisfied.

An estimated inclination value estimated in the Kalman filter-based inclination estimation operation (S140) may be input to the estimation value initialization operation (S150). In the estimation value initialization operation (S150), when the preset condition is satisfied, the estimated inclination value may be initialized, and then the initialized estimated inclination value may be input to the inclination estimation operation (S140). In the inclination estimation operation (S140), Kalman filter-based inclination estimation may be performed using the initialized estimated inclination value.

First, a wheel speed sensor may have reduced reliability due to back lash or the like at low-speed, such that it may be determined whether a low-speed condition is satisfied (S151).

When a low-speed condition in which a vehicle speed has a value equal to or less than a preset value is satisfied, a longitudinal acceleration sensor value may be processed with an LPF and set as a temporary value (S152). For example, in the low-speed condition, vehicle speed may be less than a fifth speed (for example, 0.65 m/s).

When the low-speed condition is not satisfied, the longitudinal acceleration sensor value may be set as a temporary value (S153).

Subsequently, it may be determined whether a condition immediately before stopping is satisfied (S154). When the condition immediately before stopping is satisfied, the estimated inclination value, input to the Kalman filter in the inclination estimation operation (S140), may be initialized as inclination corresponding to the longitudinal acceleration sensor value (S155).

Subsequently, it may be determined whether a vehicle stop condition is satisfied (S156). When the vehicle stop condition is satisfied, the estimated inclination value, input to the Kalman filter in the inclination estimation operation (S140), may be set as a temporary value in operation S152 or S153 (S157). Accordingly, when the vehicle stop condition is satisfied, the estimated inclination value, input to the Kalman filter, may be initialized to inclination corresponding to the longitudinal acceleration sensor value or inclination corresponding to a value obtained by processing the longitudinal acceleration sensor value with an LPF. In the low-speed condition, the longitudinal acceleration sensor value may be processed with the LPF, thereby increasing the reliability of the longitudinal acceleration sensor value.

When the condition immediately before stopping or the vehicle stop condition is not satisfied, the inclination may not be initialized (S158). That is, the estimated inclination value, input in the estimation value initialization operation (S150), may be input again to the inclination estimation operation (S140) without being initialized.

The estimated inclination value initialized in operation S155 and/or operation S157 and the estimated inclination value uninitialized in operation S158 may be returned to the inclination estimation operation (S140) (S159). In addition, the estimated inclination value initialized in operation S155 and/or S157 and the estimated inclination value uninitialized in operation S158 may be used as an estimated inclination value in operation S132 of the disturbance correction operation (S130).

Thus, when the vehicle stop condition is satisfied, the estimated inclination value, input to the Kalman filter, may be initialized to a preset value, and the initialized estimated inclination value may be input to the inclination estimation operation (S140), such that the initialized estimated inclination value may be used for inclination estimation in a next operation. Accordingly, the reliability of inclination estimation may be increased even in the vehicle stop condition.

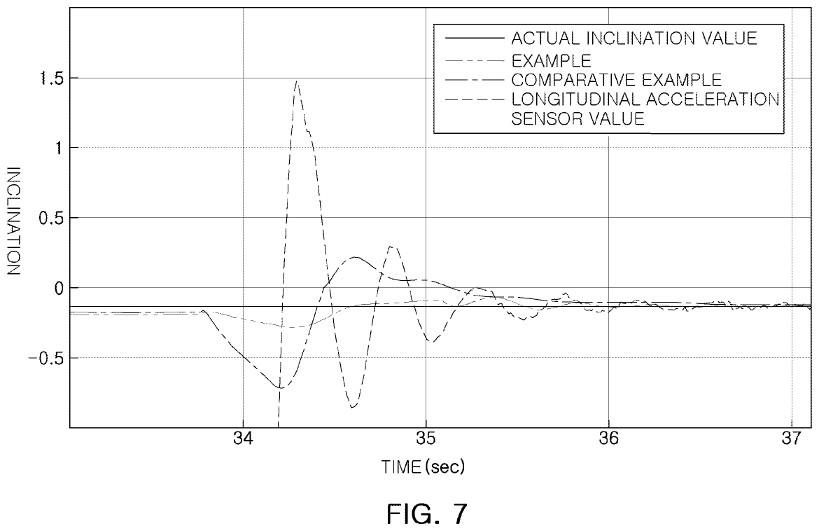

FIG. 7 is a graph illustrating inclination over time illustrating a vehicle inclination estimation method S100 according to an example and a comparative example.

FIG. 7 illustrates inclination according to a longitudinal acceleration sensor value, inclination estimated according to an example, inclination estimated by a comparative example, and an actual inclination value.

FIG. 7 illustrates a state in which braking of a vehicle is performed at about 33.8 seconds, and an actual inclination value may have a downward inclination of about 1°. In FIG. 7, inclination may be a value converted into meters per second squared (m/s²), a unit of acceleration.

Comparing the example and the comparative example with reference to FIG. 7, a percentage overshoot (POS) may have a value of about 700% in the comparative example, but may have a value of about 100% in the example. In addition, settling time to converge with the actual inclination value may be 2.2 seconds in the comparative example, but may be about 1.3 seconds in the example. That is, according to the example, it may be confirmed that an estimated value has a small variation and settling time is short, as compared to the comparative example, such that inclination estimation performance may be excellent.

Accordingly, according to the example, an estimated inclination may have high reliability and rapid response, thereby increasing the reliability of vehicle control such as a traction control system (TCS), Idle Stop and Go (ISG), cruise control system, brake hold, or the like.

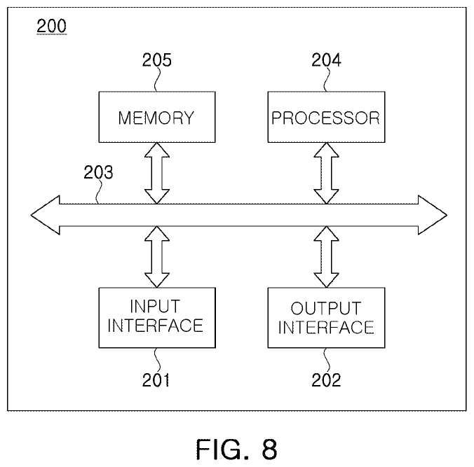

FIG. 8 is a block diagram of a computer device capable of fully or partially implementing a vehicle inclination estimation method S100 according to an example embodiment of the present disclosure.

As illustrated in FIG. 5, a computer device 200 may include an input interface 201, an output interface 202, a processor 204, and a memory 205. The input interface 201, the output interface 202, the processor 204, and the memory 205 may be interconnected via a system bus 203.

In example embodiments of the present disclosure, the memory 205 may be used to store a program, instruction or code, and the processor 204 may execute the program, instruction or code stored in the memory 205, may control the input interface 201 to receive a signal, and may control the output interface 202 to transmit a signal. The memory 205 may include read-only memory and random access memory, and may provide an instruction and data to the processor 204.

In example embodiments of the present disclosure, it should be understood that the processor 204 may be a central processing unit (CPU), and may be another general-purpose processor, a digital signal processor (DSP), an application specific integrated circuit (ASIC), a field programmable gate array (FPGA) or another programmable logic device, an individual gate or transistor logic device, an individual hardware component, or the like. The general-purpose processor may be a microprocessor, or the processor may also be any conventional processor or the like.

In an implementation process, the above-described vehicle inclination estimation method S100 may be achieved by an integrated logic circuit of hardware in the processor 204 or an instruction in the form of software. The contents of the vehicle inclination estimation method S100 disclosed in connection with example embodiments of the present disclosure may be implemented to be performed and completed by a hardware processor, or may be performed and completed by a combination of hardware and software modules of the processor. The software module may be disposed in a storage medium such as random access memory, flash memory, read-only memory, programmable read-only memory or electrically erasable programmable memory, registers, or the like. The storage medium may be positioned the memory 205, and the processor 204 may read information from the memory 205 and implement the contents of the vehicle inclination estimation method S100 in combination with hardware thereof. In order to avoid repeated descriptions, detailed descriptions thereof are omitted herein.

While example embodiments have been illustrated and described above, it will be apparent to those skilled in the art that modifications and variations could be made without departing from the scope of the present disclosure as defined by the appended claims.

The aforementioned invention can also be embodied as computer readable codes on a computer readable recording medium. The computer readable recording medium is any data storage device that can store data which can be thereafter read by a computer system and store and execute program instructions which can be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code that may be executed by a computer using an interpreter or the like.

In various exemplary embodiments of the present disclosure, each operation described above may be performed by a control device, and the control device may be configured by multiple control devices, or an integrated single control device.

In various exemplary embodiments of the present disclosure, the memory and the processor may be provided as one chip, or provided as separate chips.

In various exemplary embodiments of the present disclosure, the scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

In various exemplary embodiments of the present disclosure, the control device may be implemented in a form of hardware or software, or may be implemented in a combination of hardware and software.

In addition, the terms such as “unit”, “module”, etc. disclosed in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless particularly stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for estimating inclination of a vehicle, the apparatus comprising:
a vehicle information receiver configured to collect travel information of the vehicle including a wheel speed, a driving torque, and a longitudinal acceleration sensor value;
a vehicle stop determinator configured to determine, based on the travel information received from the vehicle information receiver, whether the vehicle satisfies a vehicle stop condition;
a disturbance corrector configured to correct disturbance of the longitudinal acceleration sensor value depending on whether the vehicle stop condition is satisfied; and
an inclination estimator configured to estimate the inclination of the vehicle using a longitudinal acceleration input value corrected by the disturbance corrector.

2. The apparatus of claim 1, wherein the vehicle stop condition is set based on the wheel speed received from the vehicle information receiver, or based on the wheel speed and the driving torque received from the vehicle information receiver.

3. The apparatus of claim 1, wherein the disturbance corrector is configured to remove the longitudinal acceleration sensor value or to set a value obtained by lowering a proportion of the longitudinal acceleration sensor value as the longitudinal acceleration input value input to the inclination estimator, in response that the vehicle stop condition is satisfied.

4. The apparatus of claim 1,
wherein the travel information collected by the vehicle information receiver further includes a lateral speed and a yaw rate of the vehicle, and
wherein the inclination estimator is configured to estimate the inclination of the vehicle through a Kalman filter using the lateral speed, the yaw rate, and the longitudinal acceleration sensor value as input thereof.

5. The apparatus of claim 4, further comprising:
a weight setting unit configured to schedule, based on vehicle information received from the vehicle information receiver, a Q gain, a system error of the Kalman filter, depending on a travel situation,
wherein the weight setting unit is configured to set a first Q gain in response that the vehicle stop condition is satisfied, and to set a second Q gain in response that a condition before stopping, corresponding to a situation before the vehicle is stopped, is satisfied.

6. The apparatus of claim 5, wherein the disturbance corrector is configured to:
remove the longitudinal acceleration sensor value or set a value obtained by lowering a proportion of the longitudinal acceleration sensor value as the longitudinal acceleration input value input to the inclination estimator, in response that the vehicle stop condition is satisfied; and
set the longitudinal acceleration sensor value as the longitudinal acceleration input value input to the inclination estimator, in response that the vehicle stop condition is not satisfied.

7. The apparatus of claim 6, wherein the first Q gain is set to have a value less than a value of the second Q gain.

8. The apparatus of claim 6,
wherein the weight setting unit is configured to set a third Q gain, in response that a vehicle speed is in a setting range in an anti-lock braking system (ABS) operation state, and
wherein the second Q gain is set to have a value greater than a value of the first Q gain and less than a value of the third Q gain.

9. The apparatus of claim 6,
wherein a condition of the ABS operation state includes a first ABS condition and a second ABS condition having a vehicle speed higher than a vehicle speed of the first ABS condition,
wherein the weight setting unit is configured to set a third Q gain, in response that the first ABS condition is satisfied, and to set a fourth Q gain, in response that the second ABS condition is satisfied, and
wherein the fourth Q gain is set to have a value greater than a value of the third Q gain.

10. The apparatus of claim 4, further comprising:
an estimated value initializer configured to initialize an estimated inclination value estimated by the inclination estimator, in response that a preset condition is satisfied;
wherein the estimated value initializer is configured to initialize the estimated inclination value to inclination corresponding to the longitudinal acceleration sensor value or inclination corresponding to a value obtained by processing the longitudinal acceleration sensor value with a low-pass filter (LPF), in response that the vehicle stop condition is satisfied, and
wherein the initialized estimated inclination value is input to the inclination estimator.

11. The apparatus of claim 10, wherein the estimated value initializer is configured to process the longitudinal acceleration sensor value with the LPF, in response that a vehicle speed satisfies a low-speed condition having a preset value or less than the preset value.

12. The apparatus of claim 10,
wherein the estimated value initializer is configured to initialize the estimated inclination value to inclination corresponding to the longitudinal acceleration sensor value, in response that a condition before stopping is satisfied, and
wherein the initialized estimated inclination value is input to the inclination estimator.

13. The apparatus of claim 12, wherein the estimated inclination value initialized by the estimated value initializer is input to the disturbance corrector and used for disturbance correction.

14. A method for estimating inclination of a vehicle, the method comprising:
a vehicle information reception operation of receiving travel information of a vehicle, wherein the travel information includes a wheel speed, a driving torque, and a longitudinal acceleration sensor value;
a disturbance correction operation of determining, based on the travel information, whether the vehicle satisfies a vehicle stop condition and correcting disturbance of the longitudinal acceleration sensor value depending on whether the vehicle satisfies the vehicle stop condition; and
an inclination estimation operation of estimating the inclination of the vehicle using a longitudinal acceleration input value corrected in the disturbance correction operation.

15. The method of claim 14, wherein the disturbance correction operation includes removing the longitudinal acceleration sensor value or setting a value obtained by lowering a proportion of the longitudinal acceleration sensor value as the longitudinal acceleration input value input to the inclination estimation operation, in response that the vehicle stop condition is satisfied.

16. The method of claim 14,
wherein the travel information received in the vehicle information reception operation further includes a lateral speed and a yaw rate of the vehicle, and
wherein the inclination estimation operation includes estimating the inclination of the vehicle through a Kalman filter using the lateral speed, the yaw rate, and the longitudinal acceleration sensor value as input thereof.

17. The method of claim 16, further comprising:
a weight setting operation of scheduling, based on the vehicle information, a Q gain, a system error of the Kalman filter, depending on a travel situation,
wherein the weight setting operation includes setting a first Q gain in response that the vehicle stop condition is satisfied, and setting a second Q gain in response that a condition before stopping, corresponding to a situation before the vehicle is stopped, is satisfied, and
wherein the first Q gain is set to have a value less than a value of the second Q gain.

18. The method of claim 16, further comprising:
an estimated value initialization operation of initializing an estimated inclination value estimated in the inclination estimation operation, in response that a preset condition is satisfied,
wherein the estimated value initialization operation includes initializing the estimated inclination value to inclination corresponding to the longitudinal acceleration sensor value or inclination corresponding to a value obtained by processing the longitudinal acceleration sensor value with a low-pass filter (LPF), in response that the vehicle stop condition is satisfied, and
wherein the initialized estimated inclination value is input to the inclination estimation operation.

19. The method of claim 18,
wherein the estimated value initialization operation includes initializing the estimated inclination value to inclination corresponding to the longitudinal acceleration sensor value, in response that a condition before stopping is satisfied, and
wherein the initialized estimated inclination value is input to the inclination estimation operation.

20. A computer-readable storage medium recording a program for executing the method described in claim 14 on a computer.
